(19) United States
(12) Patent Application Publication
(10) Pub. No.: US 2025/0149728 A1
(43) Pub. Date: May 8, 2025

(54) POWER STORAGE DEVICE

(71) Applicant: TOYOTA JIDOSHA KABUSHIKI KAISHA, Toyota-shi (JP)

(72) Inventors: Ryuma OSAKA, Toyota-shi (JP); Shungo IIZUKA, Toyota-shi (JP); Masanori KODERA, Toyota-shi (JP)

(73) Assignee: TOYOTA JIDOSHA KABUSHIKI KAISHA, Toyota-shi (JP)

(21) Appl. No.: 18/937,777

(22) Filed: Nov. 5, 2024

(30) Foreign Application Priority Data
Nov. 7, 2023 (JP) 2023-190227

(51) Int. Cl. H01M 50/358; B60R 16/04; H01M 50/209; H01M 50/249; H01M 50/271; H01M 50/291

(52) U.S. Cl. CPC H01M 50/358; B60R 16/04; H01M 50/209; H01M 50/249; H01M 50/271; H01M 50/291; H01M 2220/20

(57) ABSTRACT

A power storage device disposed at a lower portion of a vehicle includes: a plurality of power storage stacks; and an accommodation case that accommodates the power storage stacks, wherein each of the power storage stacks includes a first end surface and a second end surface arranged in a first direction, each of the power storage stacks includes a plurality of power storage cells arranged in a second direction intersecting the first direction, each of the plurality of power storage cells is formed to be elongated in the first direction, each of the plurality of power storage cells includes a discharge portion that discharges a gas inside each of the plurality of power storage cells, the first end surface is provided with one or a plurality of the discharge portions, and the second end surface is provided with one or a plurality of the discharge portions.

### CROSS REFERENCE TO RELATED APPLICATIONS

This nonprovisional application is based on Japanese Patent Application No. 2023-190227 filed on Nov. 7, 2023 with the Japan Patent Office, the entire contents of which are hereby incorporated by reference.

### BACKGROUND

### Field

The present disclosure relates to a power storage device.

### Description of the Background Art

For example, Japanese Patent Laying-Open No. 2021-048113 discloses a power storage device in which smoke from a battery cell is discharged to outside through a smoke-discharge path.

### SUMMARY

In the structure of the power storage device disclosed in Japanese Patent Laying-Open No. 2021-048113, since a discharge portion for discharging the smoke from the battery cell is oriented in one direction, it is concerned that the smoke is concentrated to cause blockage in the smoke-discharge path by debris and electrolyte solution included in the smoke.

The present disclosure has been made to solve the above-described problem, and has an object to provide a power storage device that distributes discharged smoke from a power storage cell so as to suppress hindrance of discharge of the smoke.

A power storage device according to the present disclosure is a power storage device disposed at a lower portion of a vehicle, the power storage device including: a plurality of power storage stacks; and an accommodation case that accommodates the power storage stacks, wherein each of the power storage stacks includes a first end surface and a second end surface arranged in a first direction, each of the power storage stacks includes a plurality of power storage cells arranged in a second direction intersecting the first direction, each of the plurality of power storage cells is formed to be elongated in the first direction, each of the plurality of power storage cells includes a discharge portion that discharges a gas inside each of the plurality of power storage cells, the first end surface is provided with one or a plurality of the discharge portions, and the second end surface is provided with one or a plurality of the discharge portions.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing a vehicle 10 including a power storage device 1 according to the present embodiment.

FIG. 2 is a perspective view schematically showing the power storage device according to one embodiment of the present disclosure.

FIG. 3 is an exploded perspective view of power storage device 1 shown in FIG. 2.

FIG. 4 is a perspective view schematically showing a power storage stack 101.

FIG. 5 is a perspective view schematically showing an accommodation case 200.

FIG. 6 is a cross sectional view along a line VI-VI in FIG. 3.

FIG. 7 is a diagram schematically showing a closing member 230 provided at an opening 253 according to another embodiment.

FIG. 8 is a schematic view showing a first modification of the accommodation portion.

FIG. 9 is a schematic view showing a second modification of the accommodation portion.

### DESCRIPTION OF THE PREFERRED EMBODIMENTS

Embodiments of the present disclosure will be described with reference to figures. It should be noted that in the figures described below, the same or corresponding members are denoted by the same reference characters.

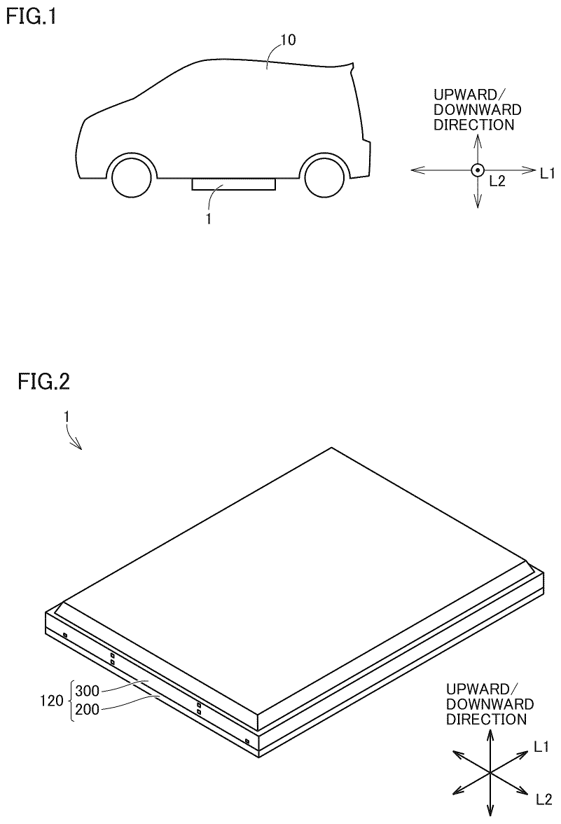

FIG. 1 is a diagram schematically showing a vehicle 10 including a power storage device 1 according to the present embodiment. Power storage device 1 is mounted, for example, at a lower portion of vehicle 10. It should be noted that the lower portion of vehicle 10 means a portion below a floor panel when vehicle 10 includes the floor panel. Further, when vehicle 10 includes no floor panel, the lower portion of vehicle 10 means a portion below a side member extending in a vehicle width direction of vehicle 10.

It should be noted that in FIG. 1 and the like, a first direction L1 indicates a frontward/rearward direction of vehicle 10, and a second direction L2 indicates the vehicle width direction of vehicle 10.

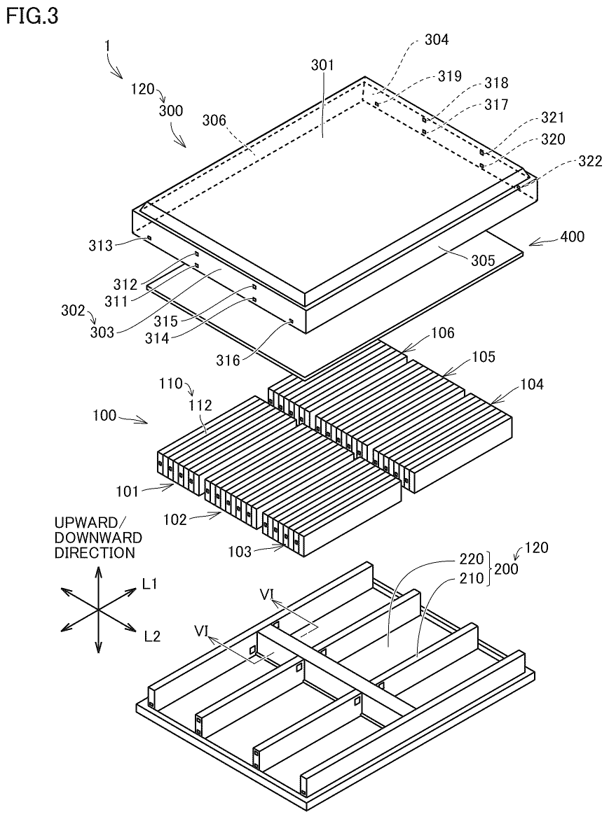

FIG. 2 is a perspective view schematically showing the power storage device according to one embodiment of the present disclosure. FIG. 3 is an exploded perspective view of power storage device 1 shown in FIG. 2.

As shown in FIG. 3, power storage device 1 includes a power storage module 100, a module case 120 that accommodates power storage module 100, and a plate 400. Module case 120 includes an accommodation case 200 and an upper cover 300. Power storage module 100 is accommodated in module case 120.

Upper cover 300 includes a top plate 301 and a peripheral wall 302. Upper cover 300 is formed to be opened downward. Peripheral wall 302 is formed so as to extend downward from an outer peripheral edge portion of top plate 301. Peripheral wall 302 includes: end walls 303 and 304 arranged in first direction L1; and side walls 305 and 306 arranged in second direction L2. External discharge ports 311 to 316 are formed in end wall 303. Moreover, external discharge ports 317 to 322 are formed in end wall 304. Each of external discharge ports 311 to 322 is a through hole.

Power storage module 100 includes a plurality of power storage stacks 101 to 106. Power storage stacks 101 to 106 are sequentially electrically connected in series. Therefore, a voltage difference between power storage stack 101 and power storage stack 106 is more than a voltage difference between power storage stack 101 and power storage stack 102.

It should be noted that each of power storage stacks 102 to 106 is formed in the same manner as power storage stack 101. Therefore, the configuration of power storage stack 101 will be described.

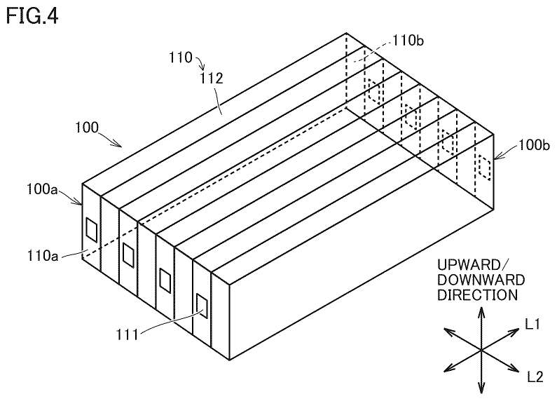

FIG. 4 shows a schematic perspective view of power storage stack 101. Power storage stack 101 includes a plurality of power storage cells 110 arranged side by side in second direction L2.

Each of power storage cells 110 is formed to be elongated in first direction L1. Power storage cell 110 is, for example, a lithium ion battery. Power storage cell 110 includes a cell case 112, as well as an electrode assembly and an electrolyte solution accommodated in cell case 112.

Cell case 112 is composed of, for example, a metal material such as aluminum. Cell case 112 includes: a first cell end surface 110a and a second cell end surface 110b arranged in first direction L1; and a discharge portion 111. Discharge portion 111 is formed in first cell end surface 110a.

For example, discharge portion 111 is formed to be thinner than a portion of cell case 112 located around discharge portion 111.

Power storage stack 101 includes a first end surface 100a and a second end surface 100b arranged in first direction L1.

First end surface 100a is formed by a plurality of first cell end surfaces 110a and a plurality of second cell end surfaces 110b. In first end surface 100a, first cell end surfaces 110a and second cell end surfaces 110b are arranged alternately in second direction L2.

Similarly, second end surface 100b includes a plurality of first cell end surfaces 110a and a plurality of second cell end surfaces 110b. In second end surface 100b, first cell end surfaces 110a and second cell end surfaces 110b are arranged alternately in second direction L2.

Therefore, first end surface 100a is provided with one or a plurality of discharge portions 111, and second end surface 100b is provided with one or a plurality of discharge portions 111.

Specifically, discharge portions 111 provided in first end surface 100a of power storage stack 101 are provided at an interval in second direction L2. Further, discharge portions 111 provided in second end surface 100b of power storage stack 101 are provided at an interval in second direction L2.

Thus, in the present embodiment, discharge portions 111 are disposed to be distributed in first cell end surfaces 110a and second cell end surfaces 110b.

In the present embodiment, it has been described that first direction L1 is defined as the frontward/rearward direction of the vehicle and second direction L2 is defined as the vehicle width direction, but the present disclosure is not limited thereto. For example, first direction L1 may be defined as the vehicle width direction, and second direction L2 may be defined as the frontward/rearward direction of the vehicle.

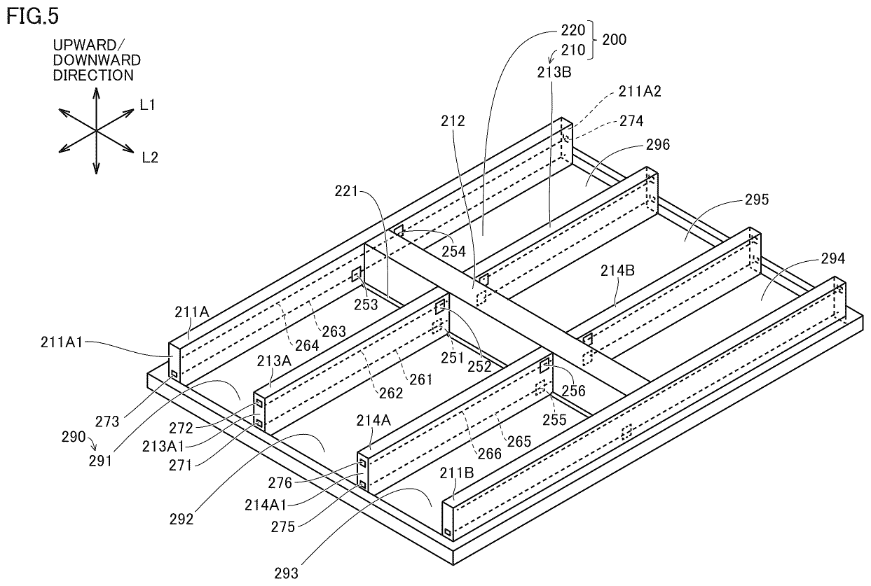

FIG. 5 is a perspective view schematically showing accommodation case 200. Accommodation case 200 includes a wall portion 210, a bottom plate 220, and a sealing member 221. Wall portion 210 and sealing member 221 are provided on an upper surface of bottom plate 220.

An outer peripheral edge portion of bottom plate 220 includes: a pair of lateral sides located at an interval in second direction L2 and extending in first direction L1; and a pair of end sides located at an interval in first direction L1 and extending in second direction L2.

Wall portion 210 includes a side wall 211A, a side wall 211B, a partition wall 212, partition walls 213A, 213B, and partition walls 214A, 214B.

Side wall 211A is formed on one lateral side of bottom plate 220 so as to extend upward from the lateral side of bottom plate 220. Side wall 211A is formed on the other lateral side of bottom plate 220 so as to extend upward from the other lateral side.

Partition wall 212 is formed on the upper surface of bottom plate 220 so as to extend in second direction L2. Partition wall 212 is disposed to extend through the center of bottom plate 220 in first direction L1.

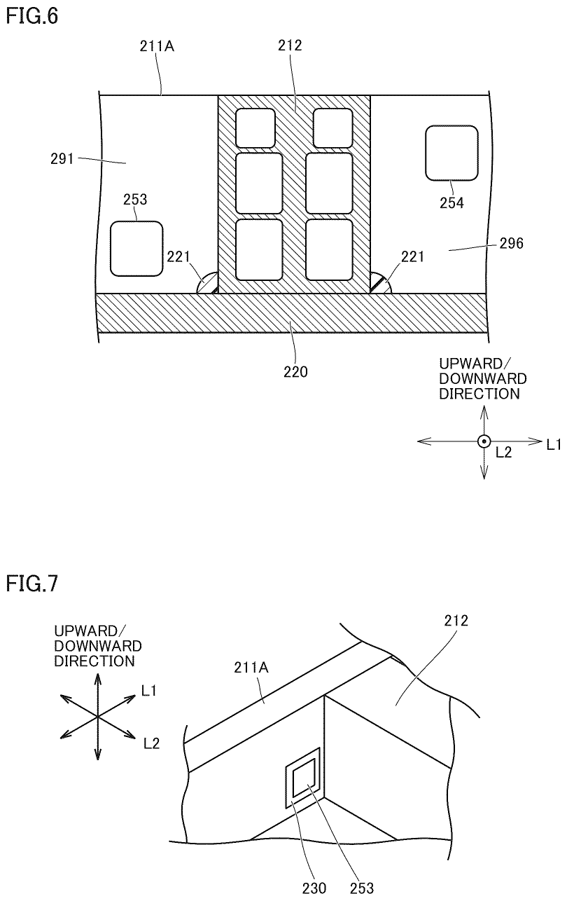

FIG. 6 is a cross sectional view along a line VI-VI in FIG. 3. Sealing member 221 is formed on the upper surface of bottom plate 220 and along an outer peripheral edge portion of a lower surface of partition wall 212 extending in second direction L2.

Return to FIG. 5 again. Each of partition wall 213A and partition wall 214A is formed to extend from one end side of bottom plate 220 toward partition wall 212. Partition wall 213A and partition wall 214A are provided at an interval in second direction L2.

Each of partition wall 213B and partition wall 214B is formed to extend from the other end side of bottom plate 220 toward partition wall 212. Partition wall 213B and partition wall 214B are provided at an interval in second direction L2.

An accommodation portion 290 is formed in accommodation case 200 by wall portion 210. Accommodation portion 290 includes accommodation portions 291 to 296. Power storage stacks 101 to 106 are accommodated in accommodation portions 291 to 296, respectively. Specifically, power storage stack 101 is accommodated in accommodation portion 291, and power storage stack 102 is accommodated in accommodation portion 292. Similarly, power storage stack 106 is accommodated in accommodation portion 296.

Accommodation portions 291, 292, 293 are formed close to the one end side of bottom plate 220 with respect to partition wall 212, and accommodation portions 294, 295, 296 are formed close to the other end side of bottom plate 220 with respect to partition wall 212.

Specifically, accommodation portion 291 is formed by side wall 211A, partition wall 212, and partition wall 213A. Accommodation portion 292 is formed by partition wall 212, partition wall 213A, and partition wall 214A. Accommodation portion 293 is formed by side wall 211B, partition wall 212, and partition wall 213A. Accommodation portion 296 is formed by side wall 211A, partition wall 212, and partition wall 213B. Accommodation portion 295 is formed by partition wall 212, partition wall 213B, and partition wall 214B. Accommodation portion 294 is formed by side wall 211B, partition wall 212, and partition wall 214B.

Accommodation portion 291 and accommodation portion 292 are arranged in second direction L2, and accommodation portion 291 and accommodation portion 296 are arranged in first direction L1. Further, side wall 211A is formed to extend from accommodation portion 291 to accommodation portion 296.

Details of side walls 211A, 211B, partition walls 213A, 213B, and partition walls 214A, 214B will be described with reference to FIG. 5.

Side wall 211A is provided with an opening 253, an opening 254, a path 263, a path 264, a discharge port 273, and a discharge port 274. Further, side wall 211A has an end surface 211A1 and an end surface 211A2. End surface 211A1 and end surface 211A2 are arranged in first direction L1 in side wall 211A. End surface 211A1 is an end surface located in the vicinity of accommodation portion 291. End surface 211A2 is an end surface located in the vicinity of accommodation portion 296.

Opening 253 is formed to be opened to accommodation portion 291, and is formed in the vicinity of partition wall 212. Opening 254 is formed to be opened to accommodation portion 296, and is formed in the vicinity of partition wall 212. It should be noted that opening 253 is located below opening 254. Each of path 263 and path 264 is formed to extend in first direction L1.

Each of path 263 and path 264 is formed in side wall 211A so as to extend in first direction L1. Path 263 communicates opening 253 and discharge port 273 with each other. Path 264 communicates opening 254 and discharge port 274 with each other.

Discharge port 273 is formed in end surface 211A1, and is provided at a position facing external discharge port 313 shown in FIG. 3. Discharge port 274 is formed in end surface 211A2, and is provided at a position facing external discharge port 319 shown in FIG. 3. Side wall 211B also has the same configuration.

In FIG. 5, partition wall 213A is provided with an opening 251, an opening 252, a path 261, a path 262, a discharge port 271, and a discharge port 272. Further, partition wall 213A has an end surface 213A1. End surface 213A1 is disposed at one end of partition wall 213A in first direction L1. End surface 213A1 is an end surface located far from partition wall 212.

Opening 251 is formed to be opened to accommodation portion 291, and is formed in the vicinity of partition wall 212. Opening 252 is formed to be opened to accommodation portion 292, and is formed in the vicinity of partition wall 212. It should be noted that opening 251 is located below opening 252.

Each of path 261 and path 262 is formed in partition wall 213A so as to extend in first direction L1. Path 261 and path 262 are formed in partition wall 213A. Path 261 communicates with opening 251 and discharge port 271. Path 262 communicates with opening 252 and discharge port 272.

Discharge port 271 is formed in end surface 213A1, and is provided at a position facing external discharge port 311. Discharge port 272 is formed in end surface 213A1, and is provided at a position facing external discharge port 312. Partition wall 213B also has the same configuration.

In FIG. 5, partition wall 214A is provided with an opening 255, an opening 256, a path 265, a path 266, a discharge port 275, and a discharge port 276. Further, partition wall 214A has an end surface 214A1. End surface 214A1 is arranged in first direction L1 in partition wall 214A. End surface 214A1 is an end surface located far from partition wall 212.

Opening 255 is formed to be opened to accommodation portion 292, and is formed in the vicinity of partition wall 212. Opening 256 is formed to be opened to accommodation portion 293, and is formed in the vicinity of partition wall 212. It should be noted that opening 255 is located below opening 256.

Each of path 265 and path 266 is formed in partition wall 214A so as to extend in first direction L1. Path 265 and path 266 are formed in partition wall 214A. Path 265 communicates with opening 255 and discharge port 275. Path 266 communicates with opening 256 and discharge port 276.

Discharge port 275 is formed in end surface 214A1, and is provided at a position facing external discharge port 314 shown in FIG. 3. Discharge port 276 is formed in end surface 214A1, and is provided at a position facing external discharge port 315 shown in FIG. 3. Partition wall 214B also has the same configuration.

In the present embodiment, each discharge portion 111 provided in power storage cell 110 is formed to be thinner than a portion of cell case 112 located around discharge portion 111. Thus, discharge portion 111 has a function to be broken by an increased internal pressure of power storage cell 110 when gas is generated in power storage cell 110. With this function of discharge portion 111, the internal pressure of power storage cell 110 can be suppressed from being increased.

First end surface 100a is provided with one or a plurality of discharge portions 111, and second end surface 100b is also provided with one or a plurality of discharge portions 111. Discharge portions 111 are not concentrated in one end surface of power storage module 100. Thus, blockage or the like due to the electrolyte solution or debris contained in the gas before the gas discharged from discharge portion 111 reaches an opening can be suppressed.

In the present embodiment, opening 252 communicates with path 262 different from the path with which opening 251 communicates. Thus, the gas generated in accommodation portion 291 and the gas generated in accommodation portion 292 do not flow into the same path, thereby suppressing blockage in each of paths 261, 262.

In the present embodiment, the gas generated from power storage stack 101 is discharged from discharge port 273 via path 263. Since discharge port 273 is provided far from accommodation portion 296, power storage stack 106 can be suppressed from being heated by the gas generated from power storage stack 101. The same applies to the gas generated from power storage stack 106.

In the present embodiment, sealing member 221 has a function of suppressing the debris and electrolyte solution contained in the gas generated in accommodation portion 291 from entering accommodation portion 296 along the upper surface of bottom plate 220. Thus, power storage stack 101 and power storage stack 106, between which the potential difference is large, can be suppressed from being short-circuited. The same applies to the gas generated in accommodation portion 296.

In the present embodiment, it has been illustratively described that the openings are opened to the accommodation portions, but the present disclosure is not limited thereto. FIG. 7 is a diagram schematically showing surroundings around opening 253 in another embodiment. For example, as shown in FIG. 7, a closing member 230 may be provided on a side surface of side wall 211A in second direction L2 so as to cover opening 253. The same applies to the other openings. Closing member 230 is, for example, an insulating film composed of polyethylene, or the like.

Closing members 230 can suppress dust or the like, which has flowed from external discharge ports 311 to 322, from being accumulated in paths 261 to 266, thereby suppressing electric connection between power storage module 100 and an external electronic device. It should be noted that only a portion of the closing member may be formed to be thinner than the surroundings so as to be readily broken when the internal pressure of accommodation portion 290 is increased. Further, closing member 230 may be provided at a discharge port or an external discharge port.

In the present embodiment, it has been illustratively described that one opening 252 communicating with path 262 is formed in accommodation portion 292, but the present disclosure is not limited thereto.

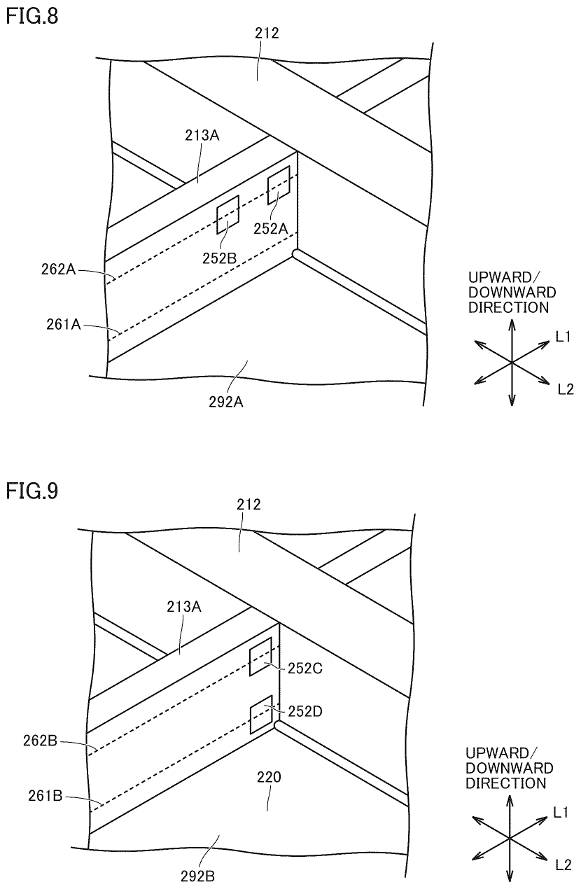

FIG. 8 is a schematic view showing a first modification of the accommodation portion. In the example shown in FIG. 8, in accommodation portion 292A, openings 252A, 252B each communicating with path 262A are formed to be arranged in first direction L1.

Thus, the plurality of openings each communicating with path 262A may be provided. Since openings 252A, 252B are formed above the upper surface of bottom plate 220, the opening areas of openings 252A, 252B can be suppressed from being small due to debris or the like accumulated on the upper surface of bottom plate 220. Further, since the plurality of openings are provided, pressure loss can be reduced by the distributed discharge paths, thereby suppressing a decrease in gas permeability in each of the gas-discharge paths.

FIG. 9 is a schematic view showing a second modification of the accommodation portion. In the example shown in FIG. 9, in accommodation portion 292B, an opening 252C communicating with path 262B and an opening 252D communicating with path 261B are formed to be arranged in the upward/downward direction.

Thus, the pair of openings 252C, 252D may be arranged in the upward/downward direction. By forming opening 252D in the vicinity of the upper surface of bottom plate 220, debris accumulated on the upper surface of bottom plate 220 can be promoted to be discharged. Thus, the debris having heat accumulated therein can be discharged to the outside, thereby suppressing imbalance in temperature distribution as well as a decrease in gas permeability due to the accumulation of the debris in the gas-discharge path.

It should be noted that since the temperature of the debris is high, a temperature around the debris is high when the debris is accumulated on the upper surface of bottom plate 220, with the result that the temperature of an adjacent cell may be increased. Meanwhile, in the example shown in FIG. 9, such a problem can be suppressed.

It should be noted that when the opening area of opening 252D formed in the vicinity of the upper surface of bottom plate 220 is larger than that of opening 252C, pressure loss of the gas-discharge path can be reduced, thereby further suppressing the imbalance in temperature distribution and the decrease in gas permeability.

In the present embodiment, it has been illustratively described that sealing member 221 is formed along the outer peripheral edge portion of the lower surface of partition wall 212 extending in second direction L2, but the present disclosure is not limited thereto. For example, sealing member 221 may be disposed along an outer peripheral edge portion of each of the lower surfaces of partition walls 213A, 214A extending in first direction L1. Thus, the electrolyte solution or the like can be suppressed from flowing along the upper surface of bottom plate 220 and entering an adjacent accommodation portion in second direction L2.

Further, sealing member 221 may be disposed along the outer peripheral edge portion of the end surface of partition wall 212 in second direction L2. Similarly, among the end surfaces of partition walls 213A, 214A in first direction L1, sealing member 221 may be disposed along an outer peripheral edge portion of each of end surfaces thereof located in the vicinity of partition wall 212. With these, the electrolyte solution or the like can be suppressed from flowing along the surface of partition wall 212 formed to extend upward from the bottom plate and entering an adjacent accommodation portion.

It should be noted that power storage stack 101 is an example of the “first power storage stack” in the present disclosure. Power storage stack 102 is an example of the “second power storage stack” in the present disclosure. Power storage stack 106 is an example of the “third power storage stack” in the present disclosure. Accommodation portion 291 is an example of the “first accommodation portion” in the present disclosure. Accommodation portion 292 is an example of the “second accommodation portion” in the present disclosure. Accommodation portion 296 is an example of the “third accommodation portion” in the present disclosure. Side wall 211A is an example of the “side wall” in the present disclosure. Partition wall 213A is an example of the “first partition wall” in the present disclosure. Partition wall 212 is an example of the “second partition wall” in the present disclosure. Opening 251 is an example of the “first opening” in the present disclosure. Path 261 is an example of the “first path” in the present disclosure. Path 262 is an example of the “second path” in the present disclosure. Opening 251 is an example of the “first opening” in the present disclosure. Opening 252 is an example of the “second opening” in the present disclosure. Opening 253 is an example of the “first side wall opening” in the present disclosure. Opening 254 is an example of the “third side wall opening” in the present disclosure. Path 263 is an example of the “first side wall path” in the present disclosure. Path 264 is an example of the “third side wall path” in the present disclosure. Discharge port 273 is an example of the “first side wall discharge port” in the present disclosure. Discharge port 274 is an example of the “third side wall discharge port” in the present disclosure.

Although the embodiments of the present disclosure have been described and illustrated in detail, it is clearly understood that the same is by way of illustration and example only and is not to be taken by way of limitation. The scope of the present disclosure is defined by the terms of the claims, and is intended to include any modifications within the scope and meaning equivalent to the terms of the claims.

What is claimed is:

1. A power storage device disposed at a lower portion of a vehicle, the power storage device comprising:
a plurality of power storage stacks; and
an accommodation case that accommodates the power storage stacks, wherein
each of the power storage stacks includes a first end surface and a second end surface arranged in a first direction,
each of the power storage stacks includes a plurality of power storage cells arranged in a second direction intersecting the first direction,
each of the plurality of power storage cells is formed to be elongated in the first direction,
each of the plurality of power storage cells includes a discharge portion that discharges a gas inside each of the plurality of power storage cells,
the first end surface is provided with one or a plurality of the discharge portions, and
the second end surface is provided with one or a plurality of the discharge portions.

2. The power storage device according to claim 1, wherein
in the first end surface, the discharge portions are provided at an interval in the second direction, and
in the second end surface, the discharge portions are provided at an interval in the second direction.

3. The power storage device according to claim 1, wherein the power storage cells are arranged in a width direction of the vehicle.

4. The power storage device according to claim 1, wherein the power storage cells are arranged in a frontward/rearward direction of the vehicle.

5. The power storage device according to claim 1, wherein
the accommodation case includes a wall portion that defines an accommodation portion that individually accommodates the plurality of power storage stacks, and
the wall portion is provided with an opening opened to the accommodation portion and a path that is formed in the wall portion and that communicates with the opening.

6. The power storage device according to claim 5, wherein
the plurality of power storage stacks include a first power storage stack and a second power storage stack,
the accommodation case is provided with a first accommodation portion that accommodates the first power storage stack and a second accommodation portion that is adjacent to the first accommodation portion in the second direction and that accommodates the second power storage stack,
the wall portion includes a first partition wall that partitions the first accommodation portion and the second accommodation portion, and
the first partition wall is provided with
a first opening opened to the first accommodation portion,
a first path that communicates with the first opening,
a second opening opened to the second accommodation portion, and
a second path that communicates with the second opening and that is different from the first path.

7. The power storage device according to claim 5, wherein
the plurality of power storage stacks include a first power storage stack and a third power storage stack,
the accommodation case is provided with a first accommodation portion that accommodates the first power storage stack and a third accommodation portion that is adjacent to the first accommodation portion in the first direction and that accommodates the third power storage stack,
the wall portion includes a side wall extending across the first accommodation portion and the third accommodation portion,
the side wall is provided with
a first side wall opening opened to the first accommodation portion,
a first side wall path that communicates with the first accommodation portion,
a first side wall discharge port with which the first side wall path communicates,
a third side wall opening opened to the third accommodation portion,
a third side wall path opened to the third accommodation portion, and
a third side wall discharge port that communicates with the third side wall path,
the first side wall discharge port is formed at a position away from the third accommodation portion, and
the third side wall discharge port is formed at a position away from the first accommodation portion.

8. The power storage device according to claim 5, wherein
the plurality of power storage stacks include a first power storage stack, a second power storage stack, and a third power storage stack,
the accommodation case includes a bottom plate provided with the wall portion,
the accommodation case is provided with
a first accommodation portion that accommodates the first power storage stack,
a second accommodation portion that is adjacent to the first accommodation portion in the second direction and that accommodates the second power storage stack, and
a third accommodation portion that is adjacent to the first accommodation portion in the first direction and that accommodates the third power storage stack,
the wall portion includes
a first partition wall that partitions the first accommodation portion and the second accommodation portion, and
a second partition wall that partitions the first accommodation portion and the third accommodation portion,
a potential difference between the first power storage stack and the third power storage stack is more than a potential difference between the first power storage stack and the second power storage stack, and
the accommodation case includes a sealing member that seals between the second partition wall and the bottom plate.

9. The power storage device according to claim 5, wherein the accommodation case includes a closing member that closes the opening.
